(19) United States
(12) Patent Application Publication
(10) Pub. No.: US 2005/0217412 A1
(43) Pub. Date: Oct. 6, 2005

(54) Steering wheel mounting assembly

(76) Inventor: Shoulian Zhu, Jacksonville, FL (US)

Correspondence Address: ROGERS TOWERS, P.A., 1301 RIVERPLACE BOULEVARD, SUITE 1500, JACKSONVILLE, FL, 32207, US

(21) Appl. No.: 10/815,360

(22) Filed: Apr. 1, 2004

(51) Int. Cl. B62D 1/04

(52) U.S. Cl. 74/552

(57) ABSTRACT

A steering wheel mounting assembly comprising a shaft having a threaded end, a coupling member mounted on said shaft and retained by a shaft nut, a steering wheel having a hub and mounted on said coupling member, and a tightening nut disposed about the shaft abutting the coupling member and connected to the steering wheel hub.

### BACKGROUND OF THE INVENTION

This invention relates generally to the field of steering wheels mounted onto steering wheel shafts, such as found on boats, motor vehicles, equipment and the like. More particularly, the invention relates to mounting assemblies that secure the steering wheel to the shaft. Even more particularly, the invention relates to mounting assemblies that require no tools for assembly and disassembly, and which present and aesthetically pleasing face to the operator.

Mechanical assemblies that secure a steering wheel to a steering wheel shaft are well known. Some assemblies require the use of tools to assemble the components. Some assemblies require access to certain components from the front or face of the steering wheel, such that a recess with an open front must be formed in steering wheel hub, typically so that a shaft nut can be threaded onto the end of the shaft. This construction is not aesthetically pleasing, and often a cover plate or cap is fitted over the recess to conceal the shaft nut. Other constructions require tightening or fastening operations to be performed internally to the assembly, such that if the connections loosen over time the assembly must be partially disassembled to provide access to the loose components.

It is an object of this invention to provide a steering wheel mounting assembly that addresses the problems found in the known art. It is an object to provide such an assembly that is aesthetically pleasing in that the components are not exposed to the front of the assembly and no access is required from the front of the assembly, thus allowing the spokes to be constructed with a solid face extending across the central hub region. It is an object to provide such an assembly that may be assembled and disassembled without tools. It is an object to provide such an assembly that requires no disassembly in order to retighten its components.

### SUMMARY OF THE INVENTION

The invention is in general a steering wheel mounting assembly for securely mounting a steering wheel onto a steering wheel shaft in a manner whereby the mounting components are not exposed or visible on the face or front side of the steering wheel. The assembly comprises a steering wheel having an externally threaded hub with an open rear and a closed front, an internally threaded tightening nut, a coupling member, an internally threaded shaft nut and an externally threaded steering wheel shaft. The hub and coupling member are provided with or designed to inherently have anti-rotation means such that independent rotation is precluded. Preferably the hub has a tapered bore adapted to receive the coupling member in a non-rotating manner. The tightening nut has a cap-like configuration and comprises an open front end, a generally closed rear end and an axial opening of sufficient diameter such that the tightening nut fits loosely onto the steering wheel shaft. The tightening nut is sized to mate with the exterior threading on the steering wheel hub. The coupling member is preferably a tapered insert or joint member with a tapered coaxial bore, shaft anti-rotation means within the bore and hub anti-rotation means on the exterior wall, whereby the coupling member bore is sized to mate with a tapered portion of the steering wheel shaft to the rear of the shaft threading, and further whereby the exterior of the coupling member is configured to mate internally with the steering wheel hub. The shaft nut is sized to mate with the threading on the steering wheel shaft.

To mount the steering wheel onto the steering wheel shaft, the tightening nut is placed onto the shaft with closed end to the rear such that the open end of the nut faces to the front of the shaft. The coupling member is placed onto the shaft with the larger diameter end of the coupling member placed first onto the shaft such that the coaxial bore tapers toward the front of the shaft, such that the coupling member reaches a point where further advancement is precluded, leaving a portion of the threading exposed on the shaft. The shaft anti-rotation means preferably comprises the combination of a longitudinally oriented key disposed into a keyway on the shaft, with a corresponding slot disposed in the coaxial bore of the coupling member. The shaft nut is then tightened onto the shaft threading, thereby securing the coupling member against movement in the axial direction. The steering wheel hub is then placed onto the coupling member, the hub anti-rotation means preventing the steering wheel from rotating independently from the shaft. The hub anti-rotation means preferably comprises at least one longitudinally oriented key disposed on the exterior wall of the coupling member and corresponding slot or slots on the bore of the steering wheel hub. Preferably the exterior of the coupling member is configured as a truncated cone with the hub bore correspondingly configured, such that the hub can be advanced only so far onto the coupling member before being precluded from further movement in the axial direction. Finally, the steering wheel hub is secured to the shaft by fastening the tightening nut onto the hub, forward movement of the tightening nut in the axial direction on the shaft being precluded by the rear end of the coupling member.

### BRIEF DESCRIPTION OF THE DRAWINGS

FIG. 1 is an exploded view of the invention.

FIG. 2 is a cross-sectional view of the assembled invention.

FIG. 3 is a front view of the steering wheel shaft.

FIG. 4 is a rear view of the coupling member.

FIG. 5 is a front view of the tightening nut.

FIG. 6 is a rear view of the steering wheel hub.

### DETAILED DESCRIPTION OF THE INVENTION

With reference to the drawings, the invention will now be described in detail with regard for the best mode and the preferred embodiment. In general, the invention is a steering wheel mounting assembly, such that a steering wheel is securely connected to a shaft in a fixed manner that precludes axial movement of the steering wheel relative to the shaft and that requires co-rotation of the steering wheel and shaft. More importantly, the invention provides a mounting assembly wherein the fastening components are not exposed on the front or face of the steering wheel, such that a single or multiple steering wheel spokes may extend in uninterrupted manner from points on the circular steering wheel rim across the steering wheel hub. For purposes of discussion herein, the terms front, forward, face and the like shall be taken to be the direction of the steering wheel assembly that would face the operator, while the terms rear, back, bottom and the like shall be taken to be the direction away from the operator, i.e., toward the distal end of the shaft.

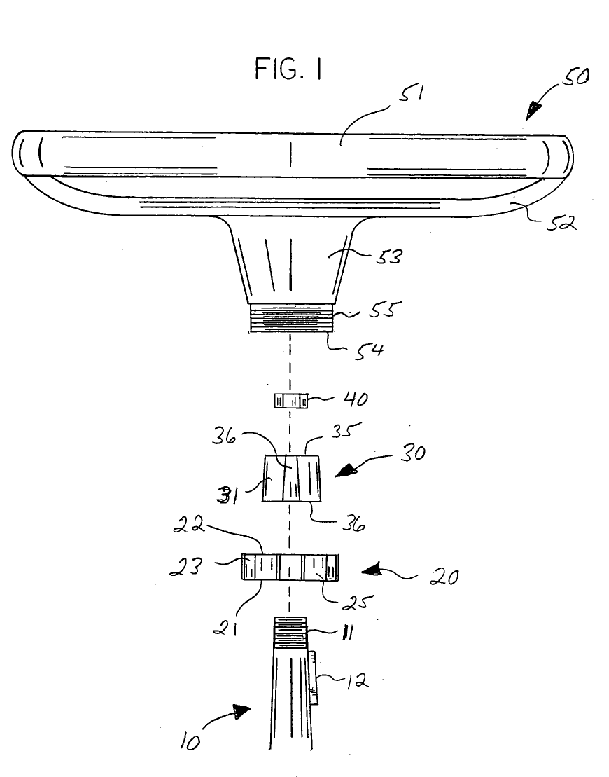

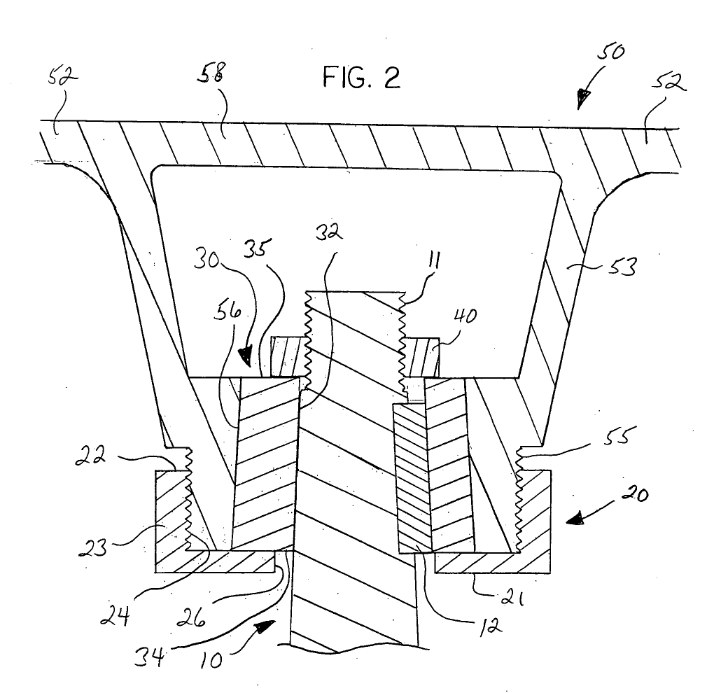

As illustrated in FIGS. 1 and 2, the steering wheel mounting assembly comprises in general a steering wheel 50, a steering wheel shaft 10, a tightening nut 20, a coupling member 30 and a steering wheel shaft nut 40. All components are preferably made of a strong, durable metal, such as for example stainless steel. The steering wheel 50 may vary in configuration, with a standard configuration comprising a circular rim 51 with a generally circular or oval cross-section sized to be easily gripped and turned by the user. One or more spokes 52 extend from the steering wheel rim 51 to the center to connect the rim 51 to the steering wheel hub 53, which is the member used to join the steering wheel 50 to the steering wheel shaft 10. The steering wheel 50 may have a single spoke stopping at the hub 53, a pair of spokes 52 extending to the hub 53, either generally linearly or V-shaped, or three or more spokes 52. The hub 53 has a closed face 58, such that the mechanical fastening components that secure the steering wheel 50 to the shaft 10 are not exposed on the front face of the steering wheel 50. In this manner the steering wheel 50 may be designed with a smooth, uninterrupted face that is aesthetically pleasing.

The hub 53, as further shown in FIG. 6, is a rearwardly extending member having a relatively large open rear end 54 and a closed forward end or face 58. As used herein, the term “closed face” shall be taken to mean an integral structural feature of the hub 53 and not a face closed by a cap or cover, and in particular such that closed face 58 in combination with spokes 52 may present a smooth, seamless surface. The hub 53 is provided with external threading 55 over a short portion adjacent the open end 54 that mates with internal threading 24 of the tightening nut 20. The interior of the hub 53 adjacent the open end 54 comprises a bore 56 to receive the coupling member 30, most preferably tapered such that the diameter of the bore 56 diminishes from the open end 54 forward. The configuration of the bore 56 corresponds to the external configuration of the coupling member 30, such that when the steering wheel mounting assembly is fully assembled the steering wheel 50 and coupling member 30 rotate together, and further such that relative axial movement between the steering wheel 50 and the coupling member 30 is precluded. Prevention of independent rotation is accomplished by providing anti-rotation means, which as shown may comprise in combination one or more longitudinally oriented exterior keys 36 disposed on the main body 31 of coupling member 30 and corresponding slots 57 disposed on the bore 56 of hub 53. Other equivalent mechanical interlocking members, such as for example splines, may be utilized as the anti-rotation means. In like manner, square, polygonal or similar cross-sectional configurations for the bore 56 and coupling member 30 may also be utilized such that independent rotation cannot occur once the components are mated.

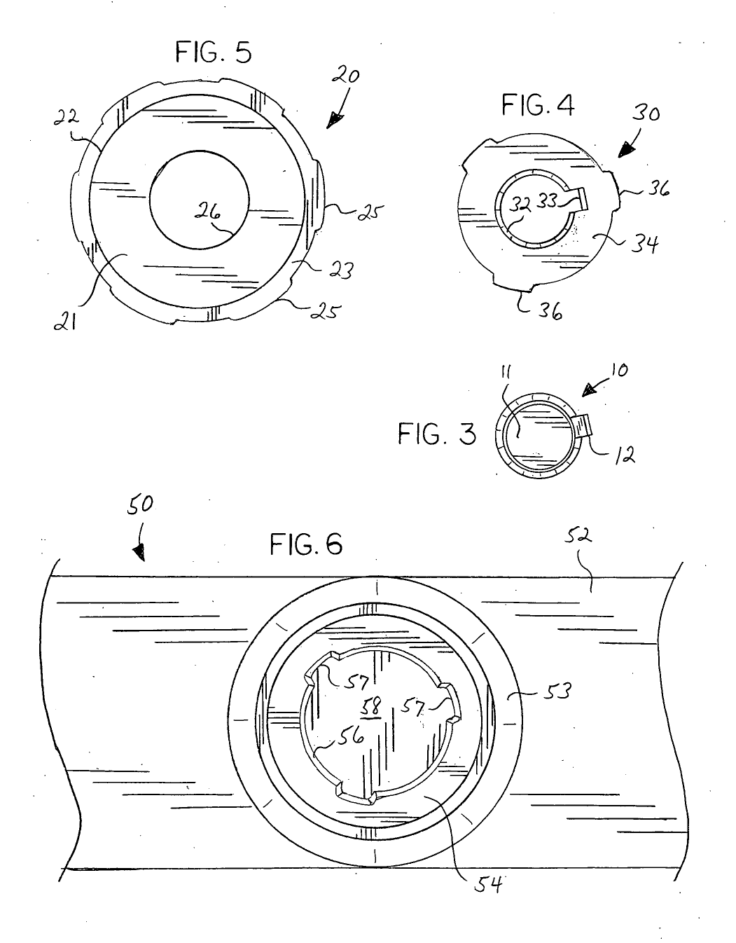

The steering wheel shaft 10, as further shown in FIG. 3, may be of standard configuration and preferably comprises a tapered portion and an externally threaded forward end 11. The shaft 10 receives a coupling member 30. Preferably a longitudinally oriented key 12 is disposed in known manner within a slot on the shaft 10, the key 12 extending outwardly from the shaft 10 and forming part of shaft anti-rotation means such that the shaft 10 and the coupling member 30 rotate together and not independently. Alternatively, the cross-sectional configuration of the shaft 10 and the bore 32 of coupling member 30 may be chosen as square, polygonal or the like to prevent independent rotation.

Coupling member 30, as further shown in FIG. 4, is the component that joins the steering wheel hub 53 to the shaft 10, and comprises a main body 31 configured externally to mate with the interior bore 56 of steering wheel hub 53. Preferably, the main body 31 is configured in the shape of a truncated cone, having a larger diameter rear end 34 and a smaller diameter forward end 35. As described above, the exterior of the main body 31 is provided with hub anti-rotation means, preferably in the form of one or more longitudinally oriented keys 36 that correspond to slots 57 disposed in the bore 56 of hub 53. In the alternative, the coupling member 30 could be provided with slots and the hub bore 56 provided with keys. Coupling member 30 further comprises a coaxial interior bore 32, preferably tapered to correspond with the tapering of the shaft 10, the bore 32 extending completely through the main body 31. The coupling member bore 32 is provided with a longitudinally extending slot 33 that corresponds to the longitudinally extending key 12 of shaft 10, the two components acting to prevent independent rotation of the coupling member 30 relative to the shaft 10. The combination of the tapered shaft 10 and the tapered bore 32 of the coupling member 30 define a stop against rearward axial movement of the coupling member 30 relative to the shaft 10, such that a significant portion of the threaded end 11 of shaft 10 extends through and beyond the forward small diameter end 35 of coupling member 30, such that internally threaded shaft nut 40 of standard configuration may be connected in known manner to the threaded end 11 of shaft 10, thereby precluding forward movement of coupling member 30 on shaft 10. Thus, with shaft nut 40 in place coupling member 30 is fixed both axially and rotationally to shaft 10.

Tightening nut 20, as also shown in FIG. 5, is disposed on shaft 10 to the rear of coupling member 30 and shaft nut 40. Tightening nut 20 is configured as an apertured cap nut, in that tightening nut 20 comprises a partially closed rear end 21, an annular wall 23 having internal threading 24, an open forward end 22 and a coaxial opening 26 disposed in the rear end 21. The coaxial opening 26 is sized such that the tightening nut 20 may be placed about the shaft 10 beyond the threaded end 11 and the key 12, such that the presence of the tightening nut 20 does not interfere with connection of the coupling member 30 to the shaft 10. The coaxial opening 26 is smaller in diameter than the large diameter end 34 of the coupling member 30 such that the coupling member 30 cannot pass through the coaxial opening 26. The height of the annular wall 23 and the configuration of the internal threading 24 is chosen such that the tightening nut 20 mates with the external threading 55 of the steering wheel hub 53. With the steering wheel 50 placed onto the coupling member 30 and shaft 10, tightening nut 20 is joined to hub 53, thereby securing the steering wheel 50 to the coupling member 30 by precluding forward movement in the axial direction. Tightening nut 20 may be provided with gripping members 25, such as for example grooves or ridges, to provide greater purchase during the tightening operation.

The steering wheel mounting assembly is assembled in the following manner. Tightening nut 20 is slipped onto shaft 10 with the open side 22 facing forward toward the threaded end 11. Coupling member 30 is pushed onto shaft 10 as far as the tapered configuration will allow, with the large diameter end 34 disposed to the rear and with slot 33 mating with key 12 of shaft 10 to preclude independent rotational movement. Shaft nut 40 is tightened onto the threaded end 11 of shaft 10 to secure coupling member 30 to shaft 10. The hub 53 of steering wheel 50 is then pushed onto the coupling member 30 and shaft 10 as far as the tapered configuration of coupling member 30 and the hub bore 56 will allow, with the slots 57 of hub bore 56 mating with the keys 36 of coupling member 30 to preclude independent rotational movement. Tightening nut 20 is now brought forward and advanced onto the threading 55 of hub 53 until its closed end 21 abuts the rear end 36 of coupling member 30, thereby securing steering wheel 50 onto the coupling member 30 and shaft 10 such that relative axial movement is precluded.

It is understood that equivalents and substitutions for certain elements set forth above may be obvious to those skilled in the art, and thus the true scope and definition of the invention is to be as set forth in the following claims.

1. A steering wheel mounting assembly comprising:
a shaft;
a coupling member positioned on said shaft;
a steering wheel comprising a rim, a hub and at least one spoke connecting said rim to said hub, said hub having an open rear end, a bore and a closed face, wherein said hub is positioned on said coupling member; and
a tightening nut disposed about said shaft and abutting said coupling member, said tightening nut joined to said hub of said steering wheel.

2. The assembly of claim 1, wherein said shaft further comprises a threaded end, and further comprising a shaft nut positioned on said threaded end.

3. The assembly of claim 1, wherein said hub further comprises threading adjacent said open rear end, and wherein said tightening nut comprises a substantially closed rear end, an annular wall having threading, an open front end and a coaxial opening.

4. The assembly of claim 3, wherein said coaxial opening is larger than said shaft and smaller than said coupling member.

5. The assembly of claim 3, wherein said threading on said hub is external and said threading on said tightening nut is internal.

6. The assembly of claim 1, further comprising hub anti-rotation means for precluding relative independent rotational movement between said hub and said coupling member.

7. The assembly of claim 6, wherein said hub anti-rotation means comprises at least one key and at least one slot corresponding to said key.

8. The assembly of claim 1, further comprising shaft anti-rotation means for precluding relative independent rotational movement between said shaft and said coupling member.

9. The assembly of claim 8, wherein said shaft anti-rotation means comprises at least one key and at least one slot corresponding to said key.

10. The assembly of claim 1, wherein said bore of said hub is tapered, and further wherein said coupling member comprises a tapered main body, a large diameter rear end, a small diameter forward end, and a tapered bore.

11. A steering wheel mounting assembly comprising:
a shaft having a threaded end;
a coupling member positioned on said shaft;
shaft anti-rotation means for precluding relative independent rotational movement between said shaft and said coupling member;
a steering wheel comprising a rim, a hub and at least one spoke connecting said rim to said hub, said hub having an open rear end, a bore and a closed face, wherein said bore of said hub is positioned on said coupling member;
hub anti-rotational means for precluding relative independent rotational movement between said hub and said coupling member;
a shaft nut positioned on said threaded end of said shaft, wherein said shaft nut retains said coupling member on said shaft; and
a tightening nut disposed about said shaft and abutting said coupling member, said tightening nut joined to said hub of said steering wheel.

12. The assembly of claim 1, wherein said hub further comprises threading adjacent said open rear end, and wherein said tightening nut comprises a substantially closed rear end, an annular wall having threading, an open front end and a coaxial opening.

13. The assembly of claim 12, wherein said coaxial opening is larger than said shaft and smaller than said coupling member.

14. The assembly of claim 12, wherein said threading on said hub is external and said threading on said tightening nut is internal.

15. The assembly of claim 11, wherein said hub anti-rotation means comprises at least one key and at least one slot corresponding to said key.

16. The assembly of claim 11, wherein said shaft anti-rotation means comprises at least one key and at least one slot corresponding to said key.

17. The assembly of claim 1, wherein said bore of said hub is tapered, and further wherein said coupling member comprises a tapered main body, a large diameter rear end, a small diameter forward end, and a tapered bore.

18. A steering wheel mounting assembly comprising:
a shaft having a threaded end;
a coupling member positioned on said shaft;
shaft anti-rotation means for precluding relative independent rotational movement between said shaft and said coupling member;
a steering wheel comprising a rim, a hub and at least one spoke connecting said rim to said hub, said hub having an open rear end, external threading, a bore and a closed face, wherein said bore of said hub is positioned on said coupling member;
hub anti-rotational means for precluding relative independent rotational movement between said hub and said coupling member;
a shaft nut positioned on said threaded end of said shaft, wherein said shaft nut retains said coupling member on said shaft; and
a tightening nut disposed about said shaft and abutting said coupling member, said tightening nut comprising a substantially closed rear end, an annular wall having threading, an open front end and a coaxial opening, said tightening nut joined to said hub of said steering wheel.

19. The assembly of claim 18, wherein said coaxial opening is larger than said shaft and smaller than said coupling member.

20. The assembly of claim 18, wherein said threading on said hub is external and said threading on said tightening nut is internal.

21. The assembly of claim 18, wherein said hub anti-rotation means comprises at least one key and at least one slot corresponding to said key.

22. The assembly of claim 18, wherein said shaft anti-rotation means comprises at least one key and at least one slot corresponding to said key.

23. The assembly of claim 18, wherein said bore of said hub is tapered, and further wherein said coupling member comprises a tapered main body, a large diameter rear end, a small diameter forward end, and a tapered bore.
